(19) United States
(12) Patent Application Publication
(10) Pub. No.: US 2008/0054575 A1
(43) Pub. Date: Mar. 6, 2008

(54) Collet reduction with extracting device

(75) Inventor: Thomas Hartmann, Holstein (CH)

Correspondence Address: HOFFMANN & BARON, LLP, 6900 JERICHO TURNPIKE, SYOSSET, NY, 11791, US

(73) Assignee: REGO-FIX AG., Tenniken (CH)

(21) Appl. No.: 11/897,074

(22) Filed: Aug. 29, 2007

(30) Foreign Application Priority Data
Aug. 30, 2006 (CH) 01385/2006

(51) Int. Cl. B23B 31/113; B23Q 3/12

(52) U.S. Cl. 279/145

(57) ABSTRACT

The collet reduction serves for inserting into a collet receptacle of a machine tool and fastening by means of a fastening nut. It is provided on its outer side, between its part on the machine side and its part on the tool side, with receiving means for receiving an element which surrounds it in an annular manner. The fastening nut engages on this element and pulls the reduction out of the receptacle during unscrewing.

### CROSS-REFERENCE TO RELATED APPLICATION

This patent application claims priority to Switzerland Patent Application No. 01385/2006, filed Aug. 30, 2006, which is hereby incorporated by reference herein.

### FIELD OF THE INVENTION

The invention relates to a collet reduction, which is mounted in a collet receptacle of a machine tool and is fixed by means of a fastening nut.

### BACKGROUND OF THE INVENTION

A collet reduction is a hollow-cylindrical part, which is produced from one piece and, on the machine side, is clamped in a larger collet receptacle by means of a fastening nut. On the cutting tool side, it is formed as a collet receptacle for receiving smaller collets. In order that the interfering contour of collet reductions can be kept small, fastening nuts that are very much smaller in diameter than customary fastening nuts are often used.

There are many ways of carrying out the removal of clamping nuts from a collet holder (chuck). Some are based on inwardly directed flanges on the inner side of a clamping nut; others are based on annular discs which are arranged in grooves of the clamping nut that run peripherally around the inside; in the case of still others, the clamping nuts have extracting tabs machined out of their inner side. All these elements are arranged inside the clamping nuts and engage in grooves in the inserted collet or engage behind flanges on the collet.

These solutions with inner extracting devices (for example extracting tabs, extracting disc, etc.) that are known from clamping nuts are not possible in the case of collet reductions.

Therefore, the collet reduction is usually removed by having to “shake” it free by means of blows with a hammer and the like. This method has disadvantages. On the one hand, it is time-consuming and needs an additional tool. On the other hand, the spindle of the machine tool with the collet receptacle or the collet holder is subjected to great mechanical stress.

### SUMMARY OF THE INVENTION

The invention is based on the object of finding a solution to overcome these disadvantages.

According to the invention, this is achieved by the collet reduction being provided on its outer side, between its part on the machine side and its part on the tool side, with receiving means for receiving an element which surrounds it in an annular manner and the outside diameter of which is greater than the inside diameter of the fastening nut.

When the fastening nut is loosened, its inner edge engages behind the surrounding element and, by its axial movement, draws the collet reduction out of the tool receptacle.

According to a preferred embodiment of the invention, a receiving means takes the form of a peripheral groove for receiving a circlip or a snap ring.

### BRIEF DESCRIPTION OF THE DRAWINGS

Preferred exemplary embodiments of the invention are described below on the basis of the accompanying drawings, in which:

FIG. 1 shows a perspective representation of a collet receptacle with an inserted reduction.

FIG. 2 shows a perspective representation of the same collet receptacle, partly in section.

FIG. 3 shows an axially parallel view, partly in section.

FIG. 4 shows a perspective, partly sectioned representation of an alternative solution.

FIG. 5 shows a perspective, partly sectioned representation of a further alternative solution.

### DETAILED DESCRIPTION OF THE INVENTION

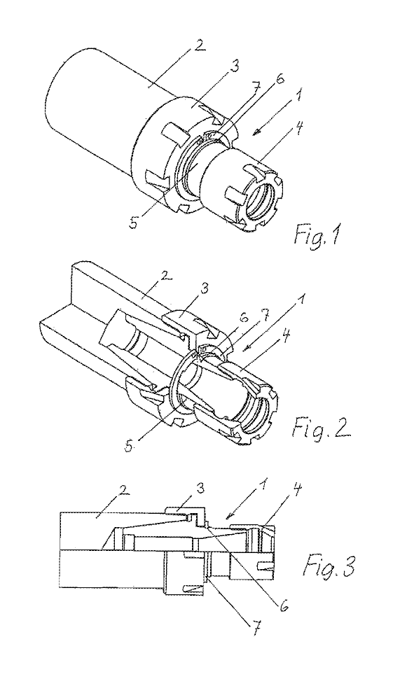

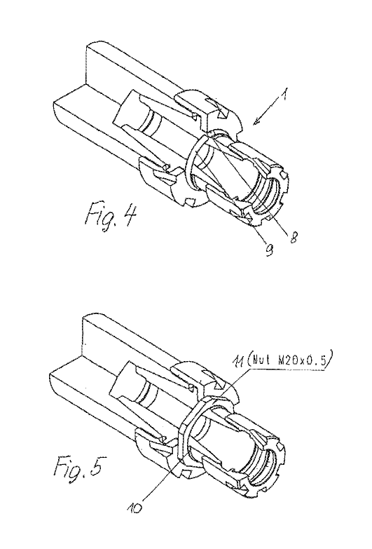

A collet reduction 1 is inserted in a collet holding means (clamping chuck) 2 and fixed with a fastening nut 3. The reduction 1 has for its part a clamping nut 4, with which a smaller collet can be fastened in it. As can be seen from the sectional representations of FIGS. 2 and 3, like a collet, the reduction 1 has on the machine side a taper which corresponds to the taper of the collet receptacle and is mounted in it. However, unlike a collet, the reduction is a one-piece rigid body.

The fastening nut 3 has a small diameter, in order to keep the interfering profile of the arrangement as small as possible. The mounting of a nut provided with an inner extracting device on a collet reduction is problematic.

The collet reduction 1 has between the seat of the fastening nut 3 on the machine side and the clamping nut 4 on the tool side an outer face 5, in the present case a cylindrical outer face, for the smaller collet that is to be inserted. Provided in this face, directly outside the seat of the fastening nut, is a peripheral groove 6 of a rectangular cross section. Arranged in this groove is a circlip 7. When the fastening nut 3 is unscrewed from the collet receptacle, it engages with its end-face inner edge on the circlip 7 and draws the reduction out of the receptacle.

In the case of the alternative embodiment shown in FIG. 4, a peripheral annular groove 8 is likewise provided in the outer face, directly outside the seat of the fastening nut 3, but has a circular cross section and serves for receiving a snap ring 9, which has the same function as the circlip.

In the case of the further embodiment shown in FIG. 5, the outer face is provided directly outside the seat of the fastening nut 3 with a thread 10, onto which there is screwed a nut 11, on which the fastening nut 3 engages during unscrewing.

While the invention has been described by reference to certain preferred embodiments, it should be understood that numerous changes could be made within the spirit and scope of the inventive concept described. Accordingly, it is intended that the invention not be limited to the disclosed embodiments, but that it have the full scope permitted by the language of the following claims.

What is claimed is:

1. Collet reduction for inserting into a collet receptacle of a machine tool and fastening by means of a fastening nut, characterized in that the collet reduction is provided on its outer side, between its part on the machine side and its part on the tool side, with receiving means for receiving an element which surrounds it in an annular manner and the outside diameter of which is greater than the inside diameter of the fastening nut.

2. Collet reduction according to claim 1, characterized in that the receiving means take the form of a groove for receiving a circlip or a snap ring.

3. Collet reduction according to claim 1, characterized in that the receiving means take the form of a thread for screwing on a nut.
